(19) United States
(12) Patent Application Publication
(10) Pub. No.: US 2025/0190000 A1
(43) Pub. Date: Jun. 12, 2025

(54) METHOD AND SYSTEM FOR COMPUTING TEMPERATURE PARAMETERS IN REDUCED-ORDER TRANSIENT CONJUGATE HEAT TRANSFER SYSTEM

(71) Applicant: Tata Consultancy Services Limited, Mumbai (IN)

(72) Inventors: Vijay Kumar Reddy VUPPULA, Pune (IN); Muralikrishnan RAMANUJAM, Pune (IN); Venkataramana RUNKANA, Pune (IN)

(73) Assignee: Tata Consultancy Services Limited, Mumbai (IN)

(21) Appl. No.: 18/968,385

(22) Filed: Dec. 4, 2024

(30) Foreign Application Priority Data
Dec. 6, 2023 (IN) 202321083211

(51) Int. Cl. G05D 23/19; H01M 10/613; H01M 10/633; H01M 10/6567

(52) U.S. Cl. CPC G05D 23/1917; H01M 10/613; H01M 10/633; H01M 10/6567

(57) ABSTRACT

To maintain a healthy and safe battery, the Battery Management System (BMS) require numerous sensors which is a costly process. Immersion cooling applications where the battery stack is cooled with a dielectric coolant fluid has complex flow patterns that are not modeled easily without high fidelity modeling. The present disclosure provides a solution by combining physics-based and data-driven techniques. Initially, a first reduced subspace and a second first reduced subspace are extracted from the high-fidelity or full-order model (FOM) data with the help of proper orthogonal decomposition (POD) in offline. Further, the dynamics of the reduced spaces (first reduced subspace and the second reduced subspace) are captured by computing the reduced coefficients. The reduced coefficients are computed by solving the reduced order equations. The reduced model is solved in the same manner as the high-fidelity or FOM model. The reduced-order solution is constructed once the reduced coefficients are obtained.

### PRIORITY CLAIM

This US patent application claims priority under 35 U.S.C. § 119 to: Indian Patent Application number 202321083211, filed on Dec. 6, 2023. The entire contents of the aforementioned application are incorporated herein by reference.

### TECHNICAL FIELD

The disclosure herein generally relates to the field of battery management and, more particularly, to a method and system for computing temperature parameters in reduced-order transient conjugate heat transfer system.

### BACKGROUND

Conjugate heat transfer is a type of heat transfer analysis between solids and fluid(s). Heat transfer in batteries of electric vehicles is an example of conjugate heat transfer, where heat dissipation in solid battery is transferred to fluids surrounding the solid battery/battery. To maintain a healthy and safe battery, a Battery Management System (BMS) is used for measuring the battery status and safety. BMS require numerous sensors for estimating the battery status and safety which is a costly process. Hence real time models like digital twins are used for predicting battery parameters thereby ensuring status and safety/health of batteries.

Conventional high-fidelity models like computational fluid dynamics (CFD) are widely being used to model parameters of various systems as they are physics-based and accurate. However, CFD is not a feasible option for digital twinning because they are computationally expensive and require large amounts of memory. Also, CFD does not provide real time predictions as needed in digital twins for prediction and optimization. Another conventional approach is to use heat transfer modeling which utilizes available empirical correlations and work well for well-defined flow paths like in a rectangular or circular coolant channels. However, immersion cooling applications where the battery stack is cooled with a dielectric coolant fluid has complex flow patterns that are challenging to be modeled as a digital twin without high fidelity modeling. Hence there is a need to transfer information from CFD to reduced order models so that it will be compatible for digital twinning and to obtain faster and fairly accurate results.

Yet another conventional approach is to use Machine Learning (ML) models and the ML models work well in interpolation of operating conditions over which the models are trained but their performance degrades drastically in extrapolation of operating conditions. Furthermore, certain machine learning models are sensitive to change in boundary conditions of the system, that means their performance is poor when the boundary conditions of the system are different from that of boundary conditions of the data used to train the model. Similar problems exist with the empirical models. Hence, there is a need for an accurate and faster method for computing parameters in conjugate heat transfer systems.

### SUMMARY

Embodiments of the present disclosure present technological improvements as solutions to one or more of the above-mentioned technical problems recognized by the inventors in conventional systems. For example, in one embodiment, a method for Computing temperature parameters in reduced-order transient conjugate heat transfer system is provided. The method includes receiving, by one or more hardware processors, a plurality of input parameters pertaining to a transient conjugate heat transfer system, wherein the plurality of input parameters comprises a heat generation parameter, a plurality of fluid parameters and a plurality of battery parameters. Further, the method includes computing by the one or more hardware processors, a plurality of fluid velocity reduced coefficients and a plurality of fluid pressure reduced coefficients associated with the conjugate heat transfer system based on a first plurality of fluid steady state reduced basis equations, the plurality of input parameters and a plurality of reduced order matrices, wherein the first plurality of fluid steady state reduced basis equations are generated by projecting a discretized form of Full Order Model (FOM) governing equations associated with the conjugate heat transfer system based on a first reduced subspace, wherein the first reduced subspace corresponding to fluid velocity and fluid pressure is computed based on the plurality of input parameters using a Proper Orthogonal Decomposition (POD) algorithm and, wherein the plurality of reduced order matrices are computed based on the first reduced subspace. Furthermore, the method includes computing, by the one or more hardware processors, a fluid velocity field and a fluid pressure field based on the plurality of fluid velocity reduced coefficients, the plurality of fluid pressure reduced coefficients and the first reduced subspace. Furthermore, the method includes computing, by the one or more hardware processors, a fluid mass flux based on the fluid velocity field and the fluid pressure field using an equation solver. Furthermore, the method includes computing, by the one or more hardware processors, a plurality of fluid temperature reduced coefficients and a plurality of battery temperature reduced coefficients associated with the conjugate heat transfer system by solving a plurality of fluid temperature transient reduced basis equations and a plurality of battery temperature transient reduced basis equations based on the plurality of input parameters and the plurality of time invariant reduced order matrices, wherein the plurality of fluid temperature transient reduced basis equations and a plurality of battery temperature transient reduced basis equations are generated by projecting the discretized form of FOM governing equations associated with the transient conjugate heat transfer system and the second reduced subspace, wherein the second reduced subspace corresponding to fluid temperature and battery temperature is computed based on the plurality of input parameters using POD algorithm, wherein the plurality of time invariant reduced order matrices are computed based on the second reduced subspace, wherein the plurality of fluid temperature transient reduced basis equations and the plurality of battery temperature transient reduced basis equations are solved separately in a sequential manner by coupling a plurality of boundary conditions associated with an interface of the battery and the fluid based on the fluid mass flux, the input parameters and the second plurality of reduced order matrices. Finally, the method includes computing, by the one or more hardware processors, the fluid temperature field and the battery temperature field associated with the transient conjugate heat transfer system based on the plurality of fluid temperature reduced coefficients and the plurality of battery temperature reduced coefficients, and the second reduced subspace.

In another aspect, a system for computing temperature parameters in reduced-order transient conjugate heat transfer system is provided. The system includes at least one memory storing programmed instructions, one or more Input/Output (I/O) interfaces, and one or more hardware processors operatively coupled to the at least one memory, wherein the one or more hardware processors are configured by the programmed instructions to receive a plurality of input parameters pertaining to a transient conjugate heat transfer system, wherein the plurality of input parameters comprises a heat generation parameter, a plurality of fluid parameters and a plurality of battery parameters. Further, the one or more hardware processors are configured by the programmed instructions to compute a plurality of fluid velocity reduced coefficients and a plurality of fluid pressure reduced coefficients associated with the conjugate heat transfer system based on a first plurality of fluid steady state reduced basis equations, the plurality of input parameters and a plurality of reduced order matrices, wherein the first plurality of fluid steady state reduced basis equations are generated by projecting a discretized form of Full Order Model (FOM) governing equations associated with the conjugate heat transfer system based on a first reduced subspace, wherein the first reduced subspace corresponding to fluid velocity and fluid pressure is computed based on the plurality of input parameters using a Proper Orthogonal Decomposition (POD) algorithm and, wherein the plurality of reduced order matrices are computed based on the first reduced subspace. Furthermore, the one or more hardware processors are configured by the programmed instructions to compute a fluid velocity field and a fluid pressure field based on the plurality of fluid velocity reduced coefficients, the plurality of fluid pressure reduced coefficients and the first reduced subspace. Furthermore, the one or more hardware processors are configured by the programmed instructions to compute a fluid mass flux based on the fluid velocity field and the fluid pressure field using an equation solver. Furthermore, the one or more hardware processors are configured by the programmed instructions to compute a plurality of fluid temperature reduced coefficients and a plurality of battery temperature reduced coefficients associated with the conjugate heat transfer system by solving a plurality of fluid temperature transient reduced basis equations and a plurality of battery temperature transient reduced basis equations based on the plurality of input parameters and the plurality of time invariant reduced order matrices, wherein the plurality of fluid temperature transient reduced basis equations and a plurality of battery temperature transient reduced basis equations are generated by projecting the discretized form of FOM governing equations associated with the transient conjugate heat transfer system and the second reduced subspace, wherein the second reduced subspace corresponding to fluid temperature and battery temperature is computed based on the plurality of input parameters using POD algorithm, wherein the plurality of time invariant reduced order matrices are computed based on the second reduced subspace, wherein the plurality of fluid temperature transient reduced basis equations and the plurality of battery temperature transient reduced basis equations are solved separately in a sequential manner by coupling a plurality of boundary conditions associated with an interface of the battery and the fluid based on the fluid mass flux, the input parameters and the second plurality of reduced order matrices. Finally, the one or more hardware processors are configured by the programmed instructions to compute the fluid temperature field and the battery temperature field associated with the transient conjugate heat transfer system based on the plurality of fluid temperature reduced coefficients and the plurality of battery temperature reduced coefficients, and the second reduced subspace.

In yet another aspect, a computer program product including a non-transitory computer-readable medium having embodied therein a computer program for computing temperature parameters in reduced-order transient conjugate heat transfer system is provided. The computer readable program, when executed on a computing device, causes the computing device to receive a plurality of input parameters pertaining to a transient conjugate heat transfer system, wherein the plurality of input parameters comprises a heat generation parameter, a plurality of fluid parameters and a plurality of battery parameters. Further, the computer readable program, when executed on a computing device, causes the computing device to compute a plurality of fluid velocity reduced coefficients and a plurality of fluid pressure reduced coefficients associated with the conjugate heat transfer system based on a first plurality of fluid steady state reduced basis equations, the plurality of input parameters and a plurality of reduced order matrices, wherein the first plurality of fluid steady state reduced basis equations are generated by projecting a discretized form of Full Order Model (FOM) governing equations associated with the conjugate heat transfer system based on a first reduced subspace, wherein the first reduced subspace corresponding to fluid velocity and fluid pressure is computed based on the plurality of input parameters using a Proper Orthogonal Decomposition (POD) algorithm and, wherein the plurality of reduced order matrices are computed based on the first reduced subspace. Furthermore, the computer readable program, when executed on a computing device, causes the computing device to compute a fluid velocity field and a fluid pressure field based on the plurality of fluid velocity reduced coefficients, the plurality of fluid pressure reduced coefficients and the first reduced subspace. Furthermore, the one or more hardware processors are configured by the programmed instructions to compute a fluid mass flux based on the fluid velocity field and the fluid pressure field using an equation solver. Furthermore, the computer readable program, when executed on a computing device, causes the computing device to compute a plurality of fluid temperature reduced coefficients and a plurality of battery temperature reduced coefficients associated with the conjugate heat transfer system by solving a plurality of fluid temperature transient reduced basis equations and a plurality of battery temperature transient reduced basis equations based on the plurality of input parameters and the plurality of time invariant reduced order matrices, wherein the plurality of fluid temperature transient reduced basis equations and a plurality of battery temperature transient reduced basis equations are generated by projecting the discretized form of FOM governing equations associated with the transient conjugate heat transfer system and the second reduced subspace, wherein the second reduced subspace corresponding to fluid temperature and battery temperature is computed based on the plurality of input parameters using POD algorithm, wherein the plurality of time invariant reduced order matrices are computed based on the second reduced subspace, wherein the plurality of fluid temperature transient reduced basis equations and the plurality of battery temperature transient reduced basis equations are solved separately in a sequential manner by coupling a plurality of boundary conditions associated with an interface of the battery and the fluid based on the fluid mass flux, the input parameters and the second plurality of reduced order matrices. Finally, computer readable program, when executed on a computing device, causes the computing device to compute the fluid temperature field and the battery temperature field associated with the transient conjugate heat transfer system based on the plurality of fluid temperature reduced coefficients and the plurality of battery temperature reduced coefficients, and the second reduced subspace.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1A is a functional block diagram of a system for computing temperature parameters in reduced-order transient conjugate heat transfer system, in accordance with some embodiments of the present disclosure.

FIG. 1B is a broad level process flow of system of FIG. 1A and can be understood with reference to method of FIG. 3.

FIG. 2 illustrates an example heat transfer system, in accordance with some embodiments of the present disclosure.

FIG. 3 (FIG. 3A and FIG. 3B) illustrates a flow diagram for a processor implemented method for computing temperature parameters in reduced-order transient conjugate heat transfer system, in accordance with some embodiments of the present disclosure.

FIG. 4 illustrates an example Root Mean Squared (RMS) Error plot between Reduced-order model and Full Order Model (FOM) model for the processor implemented method for computing temperature parameters in reduced-order transient conjugate heat transfer system, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Electric Vehicles (EV) and Hybrid Electric Vehicles (HEV) are getting importance due to the pollution caused by fossil fuel vehicles and the need for clean energy sources. The battery pack in the EVs forms an important part (for example, approximately 40% of the cost of the vehicles). A battery management system (BMS) performs the basic tasks of charging the battery pack in the vehicle and monitoring the important functions in the battery like current, voltage and temperature so that the battery does not catch fire (thermal runaway), under charge or degrade soon.

With battery systems getting more common it is important to augment the capabilities of the BMS system by enhancing the life and the energy density in the battery. Current, voltage and temperature recorded in the battery pack could be used to understand more about the behavior of the battery and optimize the use of the pack to enhance energy efficiency there by decreasing the overall running costs and battery recycling costs.

Digital twin is an efficient way to model the behavior of a real battery pack in a virtual environment and use the insights gained from the twin to optimize and predict future trends. A typical digital twin inside an electric vehicle consists of modules to predict State of Charge (SoC) and State of Health (SoH) of the battery stack. The SoH and SoC of a battery have a strong dependence on its temperature and it is essential to compute temperature parameters in an accurate manner. The ideal operating range for the battery pack is between 25 C to 35 C. At higher temperatures above that limit, the capacity of the battery degrades faster and reduces the life of the battery.

To maintain a healthy and safe battery, the BMS require numerous sensors for estimating parameters associated with the battery status and safety, which is a costly process. Hence real time models like digital twins are used for predicting battery parameters thereby ensuring status and safety of batteries. Conventional heat transfer modeling using available empirical correlations work well for well-defined flow paths like in a rectangular or circular coolant channels. However, immersion cooling applications where the battery stack is cooled with a dielectric coolant fluid has complex flow patterns that are not modeled easily without high fidelity modeling. Furthermore, some conventional approaches utilized Machine Learning (ML) model which are data driven and the ML models are sensitive to change in boundary conditions of the system, that means their performance is poor when the boundary conditions of the system are different from that of boundary conditions of the data used to train the model. Similar problems exist with the empirical models.

To overcome the challenges of the conventional approaches, embodiments herein provide a method and system for computing temperature parameters in reduced-order transient conjugate heat transfer system. The present disclosure combines physics-based and data-driven techniques to compute temperature parameters of the conjugate heat transfer system in an accurate and faster manner. Combining physics-based and data-driven techniques is a challenging process due to discrepancies between the models, nonlinearities of the physical system, dimensionality reduction, complexity of integrating models effectively, computational complexity, and need for accurate training data. Initially, a plurality of input parameters pertaining to a transient conjugate heat transfer system is received. Further, a plurality of fluid velocity reduced coefficients and a plurality of fluid pressure reduced coefficients associated with the conjugate heat transfer system is computed based on a first plurality of fluid steady state reduced basis equations, the plurality of input parameters and a plurality of reduced order matrices. Further, a fluid velocity field and a fluid pressure field are computed based on the plurality of fluid velocity reduced coefficients, the plurality of fluid pressure reduced coefficients and the first reduced subspace. Followed by that, a fluid mass flux is computed based on the fluid velocity field and the fluid pressure field using an equation solver. After computing the fluid mass flux, a plurality of fluid temperature reduced coefficients and a plurality of battery temperature reduced coefficients associated with the conjugate heat transfer system are computed. Finally, the fluid temperature field and the battery temperature field associated with the transient conjugate heat transfer system is computed based on the plurality of fluid temperature reduced coefficients and the plurality of battery temperature reduced coefficients, and the second reduced subspace.

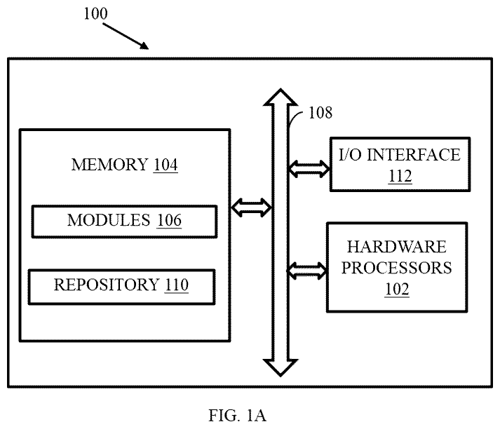

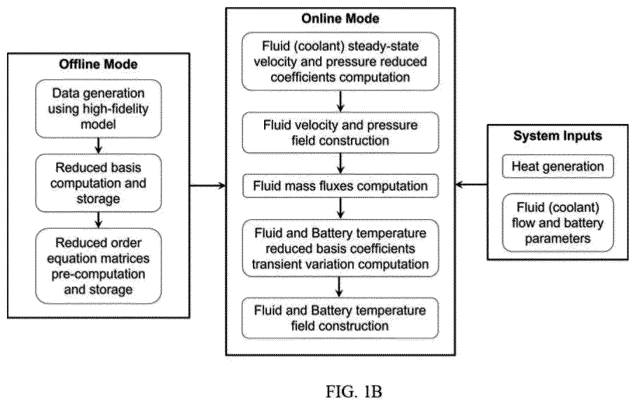

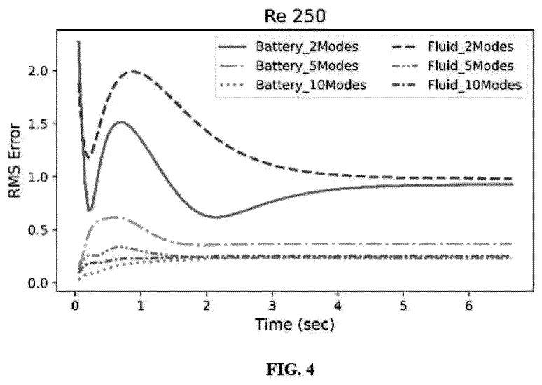

Referring now to the drawings, and more particularly to FIG. 1A through FIG. 4, where similar reference characters denote corresponding features consistently throughout the figures, there are shown preferred embodiments and these embodiments are described in the context of the following exemplary system and/or method.

FIG. 1A is a functional block diagram of a system 100 for Computing temperature parameters in reduced-order transient conjugate heat transfer system, in accordance with some embodiments of the present disclosure. The system 100 includes or is otherwise in communication with hardware processors 102, at least one memory such as a memory 104, an Input/Output (I/O) interface 112. The hardware processors 102, memory 104, and the I/O interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable the system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in the memory 104.

The memory 104 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 104 includes a plurality of modules 106. The memory 104 also includes a data repository (or repository) 110 for storing data processed, received, and generated by the plurality of modules 106.

The plurality of modules 106 include programs or coded instructions that supplement applications or functions performed by the system 100 for Computing temperature parameters in reduced-order transient conjugate heat transfer system. The plurality of modules 106, amongst other things, can include routines, programs, objects, components, and data structures, which performs particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for Computing temperature parameters in reduced-order transient conjugate heat transfer system.

The data repository (or repository) 110 may include a plurality of abstracted piece of code for refinement and data that is processed, received, or generated as a result of the execution of the plurality of modules in the module(s) 106.

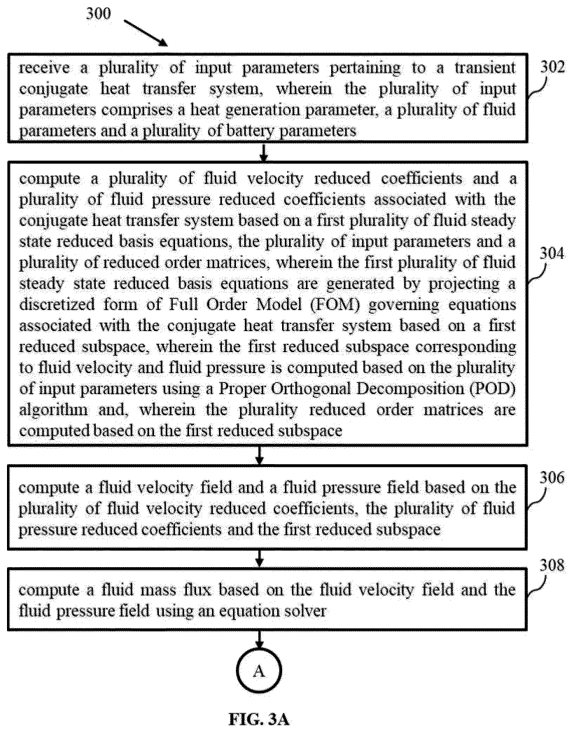

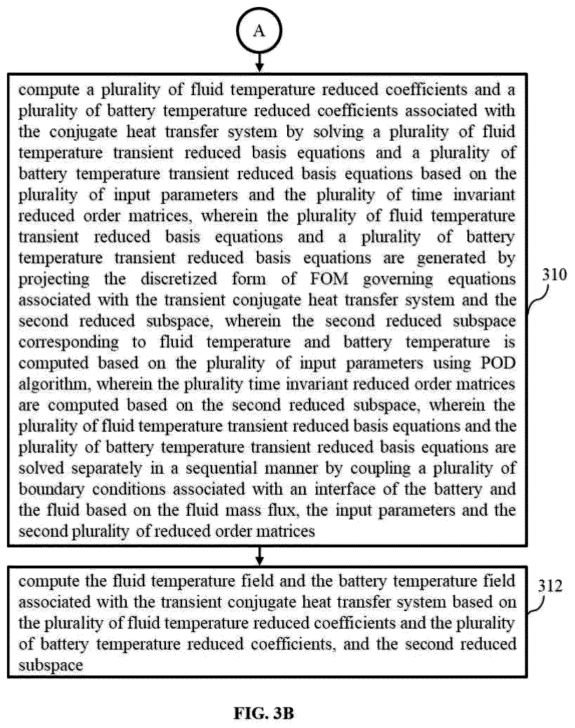

Although the data repository 110 is shown internal to the system 100, it will be noted that, in alternate embodiments, the data repository 110 can also be implemented external to the system 100, where the data repository 110 may be stored within a database (repository 110) communicatively coupled to the system 100. The data contained within such external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS). Working of the components of the system 100 are explained with reference to the method steps depicted in FIG. 3.

FIG. 1B is a broad level process flow of system of FIG. 1A and can be understood with reference to method of FIG. 3.

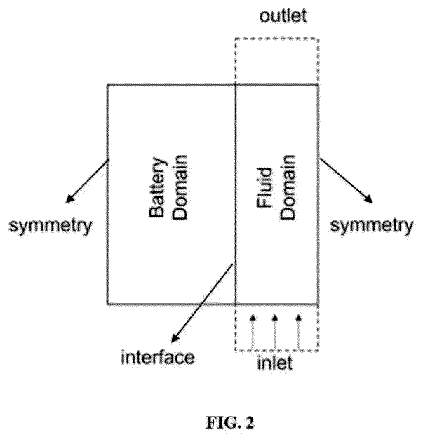

Generally, to meet the power requirements for an electric vehicle, several batteries are arranged in stack in series and parallel electrical connections. The heat generated in batteries during charge and discharge is dissipated to surrounding coolant flow, as shown in FIG. 2, to maintain the temperature of batteries in operating limit. The heat dissipation rate depends on many factors and coolant flow rate is one of them. The coolant flow rate can be adjusted by changing Reynolds number (Re) and vice versa. The Reynolds number is the ratio of inertial forces to viscous forces within a fluid that is subjected to relative internal movement due to different fluid velocities.

FIG. 3 is an exemplary flow diagrams illustrating a method 300 for computing temperature parameters in reduced-order transient conjugate heat transfer system implemented by the system of FIG. 1A according to some embodiments of the present disclosure. In an embodiment, the system 100 includes one or more data storage devices or the memory 104 operatively coupled to the one or more hardware processor(s) 102 and is configured to store instructions for execution of steps of the method 300 by the one or more hardware processors 102. The steps of the method 300 of the present disclosure will now be explained with reference to the components or blocks of the system 100 as depicted in FIG. 1A and the steps of flow diagram as depicted in FIG. 3. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communication network. The order in which the method 300 is described is not intended to be construed as a limitation, and any number of the described method blocks can be combined in any order to implement the method 300, or an alternative method. Furthermore, the method 300 can be implemented in any suitable hardware, software, firmware, or combination thereof.

At step 302 of the method 300, the one or more hardware processors 102 are configured by the programmed instructions to receive a plurality of input parameters pertaining to a transient conjugate heat transfer system, wherein the plurality of input parameters comprises a heat generation parameter, a plurality of fluid parameters and a plurality of battery parameters. For example, the plurality of fluid parameters includes fluid inlet velocity, fluid inlet temperature, fluid specific heat capacity, fluid density, fluid thermal conductivity, fluid viscosity, and coolant channel dimensions. Similarly, the plurality of battery parameters includes ambient temperature, specific heat capacity of battery, battery density, thermal conductivity of battery, and battery dimensions.

At step 304 of the method 300, the one or more hardware processors 102 are configured by the programmed instructions to compute a plurality of fluid velocity reduced coefficients and a plurality of fluid pressure reduced coefficients associated with the conjugate heat transfer system based on a first plurality of fluid steady state reduced basis equations, the plurality of input parameters and a plurality of reduced order matrices. The first plurality of fluid steady state reduced basis equations are generated offline by projecting a discretized form of Full Order Model (FOM) governing equations associated with the conjugate heat transfer system based on a first reduced subspace. The first reduced subspace corresponding to fluid velocity and fluid pressure is computed based on the plurality of input parameters using a Proper Orthogonal Decomposition (POD) algorithm. Further, the plurality of reduced order matrices are computed based on the first reduced subspace.

The plurality of fluid velocity reduced coefficients and a plurality of fluid pressure reduced coefficients are computed in online mode from their respective reduced order equations as mentioned below:

$${a}_{r}^{n + 1} = {a}_{r}^{n} + Δ t ( - {C}_{r}^{u} {a}_{r}^{n + 1} - \frac{1}{{ρ}_{F}} {G}_{r} {b}_{r}^{n + 1} + {vD}_{r}^{u} {a}_{r}^{n + 1} + {r}_{r}^{u} ) \qquad ( 1 )$$

$${L}_{r} {b}_{r}^{n + 1} = \frac{{ρ}_{F}}{Δ t} ( {M}_{r} {a}_{r}^{n} + {r}_{r}^{M} ) - {r}_{r}^{L} \qquad ( 2 )$$

Where aᵣⁿ⁺¹ and bᵣⁿ⁺¹ are the velocity and pressure reduced basis coefficients at the current time step. aᵣⁿ and bᵣⁿ are the velocity and pressure reduced basis coefficients of the previous time step. Dᵣ^{u}, Gᵣ, Lᵣ, and Mᵣ are linear Reduced order discretization operators (Reduced order matrices) and they are precomputed in offline mode once. rᵣ^{u}, rᵣ^{L}, and rᵣ^{M} are Reduced order boundary vectors (matrices) and these are also precomputed in offline mode once. Cᵣ^{u} is a nonlinear velocity Reduced order convection matrix which is computed as follows:

$${C}_{r}^{u} = {( {a}_{r}^{n} )}^{T} {C}_{1} + {( {b}_{r}^{n} )}^{T} {C}_{2} \qquad ( 3 )$$

Where C₁ is evaluated from Ψᵣ^{T}C_{P}^{u}Ψᵣ, with nonlinear convection matrix C_{P}^{u} containing flux with only velocity term, and C₂ is evaluated from Ψᵣ^{T}C_{P}^{u}Ψᵣ with C_{P}^{u} containing flux with only pressure term. Both C₁ and C₂ are precomputed once and stored as third-order tensors. C_{P}^{u} is the nonlinear velocity convection matrix.

At step 306 of the method 300, the one or more hardware processors 102 are configured by the programmed instructions to compute a fluid velocity field and a fluid pressure field based on the plurality of fluid velocity reduced coefficients, the plurality of fluid pressure reduced coefficients and the first reduced subspace.

Once reduced basis coefficient of velocity and pressure at steady state are obtained for a specific parameter then their reduced order solution is constructed as follows:

$${u}_{r} = {Ψ}_{r} {a}_{r} \qquad ( 4 )$$

$${p}_{r} = {X}_{r} {b}_{r} \qquad ( 5 )$$

Where Ψᵣ and Xᵣ are reduced sub basis of velocity and pressure fields respectively that are computed in offline mode.

At step 308 of the method 300, the one or more hardware processors 102 are configured by the programmed instructions to compute a fluid mass flux based on the fluid velocity field and the fluid pressure field using an equation solver.

At step 310 of the method 300, the one or more hardware processors 102 are configured by the programmed instructions to compute a plurality of fluid temperature reduced coefficients and a plurality of battery temperature reduced coefficients associated with the conjugate heat transfer system by solving a plurality of fluid temperature transient reduced basis equations and a plurality of battery temperature transient reduced basis equations based on the plurality of input parameters and the plurality of time invariant reduced order matrices. The plurality of fluid temperature transient reduced basis equations and a plurality of battery temperature transient reduced basis equations are generated offline by projecting the discretized form of FOM governing equations associated with the transient conjugate heat transfer system and the second reduced subspace. The second reduced subspace corresponding to fluid temperature and battery temperature is computed based on the plurality of input parameters using POD algorithm. The plurality of time invariant reduced order matrices are computed based on the second reduced subspace using. The plurality of fluid temperature transient reduced basis equations and the plurality of battery temperature transient reduced basis equations are solved separately in a sequential manner by coupling a plurality of boundary conditions associated with an interface of the battery and the fluid based on the fluid mass flux, the input parameters and the plurality of time invariant reduced order matrices.

The plurality of fluid temperature reduced coefficients and a plurality of battery temperature reduced coefficients are computed by solving the corresponding plurality of fluid temperature transient reduced basis equations and the plurality of battery temperature transient reduced basis equations as shown below:

$${c}^{n + 1} = {c}^{n} + Δ t ( - {C}_{r}^{a} {c}^{n + 1} + {α}_{F} {D}_{r}^{a} {c}^{n + 1} + {r}_{r}^{a} ) \qquad ( 6 )$$

$${d}^{n + 1} = {d}^{n} + Δ t ( {α}_{S} {D}_{r}^{b} {d}^{n + 1} + {Q}_{{g}_{r}} + {r}_{r}^{b} ) \qquad ( 7 )$$

Where cᵣⁿ⁺¹ and dᵣⁿ⁺¹ are the fluid and battery temperature reduced basis coefficients at the current time step. cᵣⁿ and dᵣⁿ are the fluid and battery temperature reduced basis coefficients of the previous time step. Cᵣ^{a}, Dᵣ^{a}, and Dᵣ^{b} are reduced order discretization operators (plurality of time invariant reduced order matrices). rᵣ^{a} and rᵣ^{b} are the reduced order boundary vectors (matrices). Q_{g}_{ᵣ} is the reduced order heat generation vector (matrix). All these matrices are precomputed once in offline mode. At every time-step, the battery domain temperature equation is solved first with the temperature at interface T_{S}_{_{1F}} computed using heat flux as Neumann boundary condition from the fluid domain. After the solid domain temperature solution, the fluid domain temperature equation is solved with the temperature at interface T_{F}_{_{1F}} computed by using Dirichlet boundary condition as mentioned in equation

$${T}_{IF} = \frac{{C}_{S} {T}_{{S}_{P}} + {C}_{F} {T}_{{F}_{P}}}{{C}_{S} + {C}_{F}} .$$

This procedure is repeated until the difference between T_{S}_{_{1F}} and T_{F}_{_{1F}} is less than 10⁻⁵, proceeding to the next time-step. The time-stepping is continued till the steady-state is reached. The reduced basis solution of fluid and battery temperature are stored in separate matrices to couple them at the interface.

At step 312 of the method 300, the one or more hardware processors 102 are configured by the programmed instructions to compute the fluid temperature field and the battery temperature field associated with the transient conjugate heat transfer system based on the plurality of fluid temperature reduced coefficients and the plurality of battery temperature reduced coefficients, and the second reduced subspace.

Once reduced basis coefficient of fluid domain and battery domain temperature are obtained then their reduced order solution is constructed as follows:

$${T}_{{F}_{r}} = {Φ}_{r} {c}_{r} \qquad ( 8 )$$

$${T}_{{S}_{r}} = {Z}_{r} {d}_{r} \qquad ( 9 )$$

Where Φᵣ, and Zᵣ are reduced basis for fluid temperature and battery temperature fields.

Test Case Results: In an embodiment, the reduced order solution is constructed for seven different Reynolds numbers, Reᵣ∈(250, 500, 750, 1000, 1250, 1500, 1750). The reduced basis is calculated using three Reynolds numbers, Reₚ∈(250, 750, 1250), FOM simulation data and reduced order solution is constructed for all seven Reynolds numbers, Reᵣ. Even though the reduced basis is extracted only from the data of Reₚ, the ROM solution constructed for all the Reynolds numbers Reᵣ is accurate.

An example Root Mean Squared (RMS) error plot of fluid and battery ROM temperature solution with respect to FOM as a function of time up to steady-state for the Reynolds number Reᵣ 250 with 2, 5, and 10 modes is shown in Error! Reference source not found. The RMS error of fluid and battery temperature ROM solution is around 1.5K with 2 modes and within 0.5K with 5 modes for all the seven Reynolds numbers Reᵣ. It is observed that, for constructing the fluid and battery temperature ROM solution, 5 modes are sufficient as there is no significant variation in the solution with further increase in the number of modes. The ROM computational speed-up with respect to FOM is 8.6-13.8 times with 2 modes and approximately 4-7.4 times with 5 modes.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address the unresolved problem of Computing temperature parameters in reduced-order transient conjugate heat transfer system. The present disclosure provides temperature results about orders of magnitude faster compared to FOM. The present disclosure works well both in the interpolation and extrapolation regions. Further, the present solves FOM governing equations to compute reduced-order coefficients. Here, the battery and fluid (coolant) domains are solved separately and coupled at interface by storing reduced sub space values of interface temperature in separate matrices in such a way that they can be used in the computations directly.

It is to be understood that the scope of the protection is extended to such a program and in addition to a computer-readable means having a message therein such computer-readable storage means contain program-code means for implementation of one or more steps of the method when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs, GPUs and edge computing devices.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e. non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method comprising:
receiving, by one or more hardware processors, a plurality of input parameters pertaining to a transient conjugate heat transfer system, wherein the plurality of input parameters comprises a heat generation parameter, a plurality of fluid parameters and a plurality of battery parameters;
computing, by the one or more hardware processors, a plurality of fluid velocity reduced coefficients and a plurality of fluid pressure reduced coefficients associated with the conjugate heat transfer system based on a first plurality of fluid steady state reduced basis equations, the plurality of input parameters and a plurality of reduced order matrices,
wherein the first plurality of fluid steady state reduced basis equations are generated by projecting a discretized form of Full Order Model (FOM) governing equations associated with the conjugate heat transfer system based on a first reduced subspace,
wherein the first reduced subspace corresponding to fluid velocity and fluid pressure is computed based on the plurality of input parameters using a Proper Orthogonal Decomposition (POD) algorithm and, wherein the plurality of reduced order matrices are computed based on the first reduced subspace;
computing, by the one or more hardware processors, a fluid velocity field and a fluid pressure field based on the plurality of fluid velocity reduced coefficients, the plurality of fluid pressure reduced coefficients and the first reduced subspace;
computing, by the one or more hardware processors, a fluid mass flux based on the fluid velocity field and the fluid pressure field using an equation solver;
computing, by the one or more hardware processors, a plurality of fluid temperature reduced coefficients and a plurality of battery temperature reduced coefficients associated with the conjugate heat transfer system by solving a plurality of fluid temperature transient reduced basis equations and a plurality of battery temperature transient reduced basis equations based on the plurality of input parameters and the plurality of time invariant reduced order matrices,
wherein the plurality of fluid temperature transient reduced basis equations and a plurality of battery temperature transient reduced basis equations are generated by projecting the discretized form of FOM governing equations associated with the transient conjugate heat transfer system and the second reduced subspace,
wherein the second reduced subspace corresponding to fluid temperature and battery temperature is computed based on the plurality of input parameters using POD algorithm, wherein the plurality of time invariant reduced order matrices are computed based on the second reduced subspace and,
wherein the plurality of fluid temperature transient reduced basis equations and the plurality of battery temperature transient reduced basis equations are solved separately in a sequential manner by coupling a plurality of boundary conditions associated with an interface of the battery and the fluid based on the fluid mass flux, the input parameters and the second plurality of reduced order matrices; and
computing, by the one or more hardware processors, the fluid temperature field and the battery temperature field associated with the transient conjugate heat transfer system based on the plurality of fluid temperature reduced coefficients and the plurality of battery temperature reduced coefficients, and the second reduced subspace.

2. The processor implemented method of claim 1, wherein the high-fidelity full order model data comprises a plurality of parameters, the plurality of boundary conditions and a plurality of time instants.

3. The processor implemented method of claim 1, wherein the plurality of fluid parameters comprises fluid inlet velocity, fluid inlet temperature, fluid specific heat capacity, fluid density, fluid thermal conductivity, fluid viscosity, and coolant channel dimensions.

4. The processor implemented method of claim 1, wherein the plurality of battery parameters comprises ambient temperature, specific heat capacity of battery, battery density, thermal conductivity of battery, and battery dimensions.

5. A system comprising:
at least one memory storing programmed instructions; one or more Input/Output (I/O) interfaces; and one or more hardware processors operatively coupled to the at least one memory, wherein the one or more hardware processors are configured by the programmed instructions to:
receive a plurality of input parameters pertaining to a transient conjugate heat transfer system, wherein the plurality of input parameters comprises a heat generation parameter, a plurality of fluid parameters and a plurality of battery parameters;
compute a plurality of fluid velocity reduced coefficients and a plurality of fluid pressure reduced coefficients associated with the conjugate heat transfer system based on a first plurality of fluid steady state reduced basis equations, the plurality of input parameters and a plurality of reduced order matrices,
wherein the first plurality of fluid steady state reduced basis equations are generated by projecting a discretized form of Full Order Model (FOM) governing equations associated with the conjugate heat transfer system based on a first reduced subspace,
wherein the first reduced subspace corresponding to fluid velocity and fluid pressure is computed based on the plurality of input parameters using a Proper Orthogonal Decomposition (POD) algorithm and, wherein the plurality of reduced order matrices are computed based on the first reduced subspace;
compute a fluid velocity field and a fluid pressure field based on the plurality of fluid velocity reduced coefficients, the plurality of fluid pressure reduced coefficients and the first reduced subspace;
compute a fluid mass flux based on the fluid velocity field and the fluid pressure field using an equation solver;
compute a plurality of fluid temperature reduced coefficients and a plurality of battery temperature reduced coefficients associated with the conjugate heat transfer system by solving a plurality of fluid temperature transient reduced basis equations and a plurality of battery temperature transient reduced basis equations based on the plurality of input parameters and the plurality of time invariant reduced order matrices,
wherein the plurality of fluid temperature transient reduced basis equations and a plurality of battery temperature transient reduced basis equations are generated by projecting the discretized form of FOM governing equations associated with the transient conjugate heat transfer system and the second reduced subspace,
wherein the second reduced subspace corresponding to fluid temperature and battery temperature is computed based on the plurality of input parameters using POD algorithm, wherein the plurality of time invariant reduced order matrices are computed based on the second reduced subspace and,
wherein the plurality of fluid temperature transient reduced basis equations and the plurality of battery temperature transient reduced basis equations are solved separately in a sequential manner by coupling a plurality of boundary conditions associated with an interface of the battery and the fluid based on the fluid mass flux, the input parameters and the second plurality of reduced order matrices; and
compute the fluid temperature field and the battery temperature field associated with the transient conjugate heat transfer system based on the plurality of fluid temperature reduced coefficients and the plurality of battery temperature reduced coefficients, and the second reduced subspace.

6. The system of claim 5, wherein the high-fidelity full order model data comprises a plurality of parameters, the plurality of boundary conditions and a plurality of time instants.

7. The system of claim 5, wherein the plurality of fluid parameters comprises fluid inlet velocity, fluid inlet temperature, fluid specific heat capacity, fluid density, fluid thermal conductivity, fluid viscosity, and coolant channel dimensions.

8. The system of claim 5, wherein the plurality of battery parameters comprises ambient temperature, specific heat capacity of battery, battery density, thermal conductivity of battery, and battery dimensions.

9. One or more non-transitory machine-readable information storage mediums comprising one or more instructions which when executed by one or more hardware processors cause:
receiving a plurality of input parameters pertaining to a transient conjugate heat transfer system, wherein the plurality of input parameters comprises a heat generation parameter, a plurality of fluid parameters and a plurality of battery parameters;
computing a plurality of fluid velocity reduced coefficients and a plurality of fluid pressure reduced coefficients associated with the conjugate heat transfer system based on a first plurality of fluid steady state reduced basis equations, the plurality of input parameters and a plurality of reduced order matrices,
wherein the first plurality of fluid steady state reduced basis equations are generated by projecting a discretized form of Full Order Model (FOM) governing equations associated with the conjugate heat transfer system based on a first reduced subspace,
wherein the first reduced subspace corresponding to fluid velocity and fluid pressure is computed based on the plurality of input parameters using a Proper Orthogonal Decomposition (POD) algorithm and, wherein the plurality of reduced order matrices are computed based on the first reduced subspace;
computing a fluid velocity field and a fluid pressure field based on the plurality of fluid velocity reduced coefficients, the plurality of fluid pressure reduced coefficients and the first reduced subspace;
computing a fluid mass flux based on the fluid velocity field and the fluid pressure field using an equation solver;
computing a plurality of fluid temperature reduced coefficients and a plurality of battery temperature reduced coefficients associated with the conjugate heat transfer system by solving a plurality of fluid temperature transient reduced basis equations and a plurality of battery temperature transient reduced basis equations based on the plurality of input parameters and the plurality of time invariant reduced order matrices,
wherein the plurality of fluid temperature transient reduced basis equations and a plurality of battery temperature transient reduced basis equations are generated by projecting the discretized form of FOM governing equations associated with the transient conjugate heat transfer system and the second reduced subspace,
wherein the second reduced subspace corresponding to fluid temperature and battery temperature is computed based on the plurality of input parameters using POD algorithm, wherein the plurality of time invariant reduced order matrices are computed based on the second reduced subspace and,
wherein the plurality of fluid temperature transient reduced basis equations and the plurality of battery temperature transient reduced basis equations are solved separately in a sequential manner by coupling a plurality of boundary conditions associated with an interface of the battery and the fluid based on the fluid mass flux, the input parameters and the second plurality of reduced order matrices; and
computing the fluid temperature field and the battery temperature field associated with the transient conjugate heat transfer system based on the plurality of fluid temperature reduced coefficients and the plurality of battery temperature reduced coefficients, and the second reduced subspace.

10. The one or more non-transitory machine-readable information storage mediums of claim 9, wherein the high-fidelity full order model data comprises a plurality of parameters, the plurality of boundary conditions and a plurality of time instants.

11. The one or more non-transitory machine-readable information storage mediums of claim 9, wherein the plurality of fluid parameters comprises fluid inlet velocity, fluid inlet temperature, fluid specific heat capacity, fluid density, fluid thermal conductivity, fluid viscosity, and coolant channel dimensions.

12. The one or more non-transitory machine-readable information storage mediums of claim 9, wherein the plurality of battery parameters comprises ambient temperature, specific heat capacity of battery, battery density, thermal conductivity of battery, and battery dimensions.
